(19) United States
(12) Patent Application Publication
(10) Pub. No.: US 2026/0134403 A1
(43) Pub. Date: May 14, 2026

(54) SMART SCHEDULING MACHINE

(71) Applicant: CVS Pharmacy, Inc., Woonsocket, RI (US)

(72) Inventors: Vanteya Pandit, North Attleboro, MA (US); Santosh Ayyappa Singam, Cumberland, RI (US); Showeb Ahmad Siddiqui, Lincoln, RI (US)

(21) Appl. No.: 18/946,833

(22) Filed: Nov. 13, 2024

(51) Int. Cl. G06Q 10/1093; G06Q 10/0631

(52) U.S. Cl. CPC G06Q 10/1093; G06Q 10/06312

(57) ABSTRACT

A system, method, and apparatus are provided that include a system having a scheduling machine with: a plurality of configuration data sets; and a rules engine that generates a response to a timeslot request by applying a plurality of rules to the timeslot request, where the plurality of rules utilize the plurality of configuration data sets as inputs thereto, and where the rules engine resolves one or more conflicts and eliminates timeslots that would otherwise be available if a booking of such a timeslot would result in a violation of a rule in the plurality of rules.

### FIELD OF THE DISCLOSURE

The disclosure relates to systems and methods for intelligently scheduling resources and customer appointments therewith, and more particularly, Artificial Intelligence (AI)-based systems and methods for tracking and predicting resource availability and then scheduling such resources based on the predictions associated therewith.

### BACKGROUND

Resource availability or the lack thereof is a well-understood problem and has been studied a great deal. Issues still exist within the context of resource availability and the allocation thereof.

One such problem associated with resource allocation relates to the difficulty associated with optimizing slot availability for various resources and the services that can be offered by those resources within a clinical setting. More specifically, the challenges still facing resource/service allocation to patients in a clinical setting include: (i) a complex eco system with various information technology (IT) systems involved; (ii) restrictions existing due to pre-defined templates which don't allow for dynamic adaptability to clinical care model; (iii) a lack of consideration for seasonal customer behavior; and (iv) a lack of conscious or dynamic rules to adapt to current clinical conditions, resource availability, and/or patient needs.

### SUMMARY

It is with respect to the above-noted issues that examples of the present disclosure were contemplated. In particular, an intelligent scheduling machine is described herein with the ability to leverage analytical insights derived from past clinic visits, seasonality, and clinic volume to define parameters that govern the behavior of the scheduling machine. Using the analytical insights, the system proposed herein can automatically provide additional slots for appointment staggering, maintain a defined Visits Per Hour (VPH), and apply conscious rules based on time thresholds, which further maximize the slot availability for clinical appointments.

According to at least some examples of the present disclosure, a system is provided with the ability to: (i) provide real-time slot availability computation that doesn't depend on patient history or past appointments; (ii) utilize an intelligent rules-based configuration; (iii) provide dynamic slot availability for multiple resources (e.g., care providers) in a single location with appropriate patient placement; (iv) provide dynamic slot availability to reflect changes in staffing, operational hours, etc.; (v) adjust availability based on seasonality and/or geographic location.

In one aspect, a system is provided that includes: a processor; memory comprising data stored therein that is executable by the processor, wherein the data stored in the memory comprises: user portal instructions that facilitate communications with one or more communication devices, wherein the user portal instructions are configured to receive a request for access to a resource in the form of a timeslot request; a scheduling machine, comprising: a plurality of configuration data sets; and a rules engine that generates a response to the timeslot request by applying a plurality of rules to the timeslot request, wherein the plurality of rules utilize the plurality of configuration data sets as inputs thereto, and wherein the rules engine resolves one or more conflicts and eliminates timeslots that would otherwise be available if a booking of such a timeslot would result in a violation of a rule in the plurality of rules; and a network interface that facilitates communication between the processor and the one or more communication devices via a communication network, wherein the network interface carries the timeslot request from the one or more communication devices to the processor and wherein the network interface provides the response to the timeslot request to the one or more communication devices.

Examples may include one of the following features, or any combination thereof.

In one example, the user portal instructions comprise instructions that facilitate interactions with the one or more communication devices via a web browser.

In one example, the plurality of configuration data sets comprises at least one of an analytic insights data set, an administrative configuration data set, and an appointment configuration data set.

In one example, the memory further stores one or more machine learning models that are usable by the rules engine to identify one or more available timeslots.

In one example, the one or more machine learning models receive an input from the rules engine identifying candidate timeslots and resources associated therewith and wherein the one or more machine learning models provide a prediction of availability with respect to the resources associated with the candidate timeslots.

In one example, the scheduling machine further comprises a cache that stores information describing at least one of clinic hours, scheduling hours, clinical models, and configuration data.

In one example, the scheduling machine further comprises a cache Application Programming Interface (API) that facilitates interactions between the cache and a scheduling machine server.

In one example, the plurality of configuration data sets comprise at least one data set that dynamically changes in response to resource conditions.

In one example, the at least one data set that dynamically changes in response to resource conditions is adjusted based on seasonal variations in resource availability.

In one example, the system further includes one or more machine learning models that are trained with historical resource availability data and timeslot allocation data and, based on the training thereof, develop an understanding of the seasonal variations in resource availability.

In one example, the scheduling machine is configured to support a soft reservation for a resource during at least one timeslot.

In one example, the rules engine applies a first set of rules to the timeslot request when received from a kiosk, but applies a second set of rules to the timeslot request when received from a communication device other than a kiosk, and wherein the first set of rules is different from the second set of rules.

In one example, the first set of rules presents a different set of available timeslots in response to the timeslot request as compared to the second set of rules.

In one example, the scheduling machine is configured to run a plurality of rules updates in the form of a batch process.

In one example, at least one rules update in the plurality of rules updates is triggered in response to the scheduling machine detecting an anomaly in resource availability.

In one example, the response to the timeslot request comprises an indication of at least one of appointment availability, appointment type, and resource type.

In one example, the communication network is untrusted with respect to an administrator of the scheduling machine.

In one example, the plurality of configuration data sets provide a definition of permissible hourly Visits Per Hour (VPH), daily VPH, and clinic VPH.

In one example, the scheduling machine is configured to perform two or more of a get scheduling slots, a get clinic slots, and a get day slots operation in parallel.

In one example, the processor comprises at least one of a microprocessor, a Central Processing Unit (CPU), and a Graphics Processing Unit (GPU).

All examples and features mentioned above can be combined in any technically possible way.

### BRIEF DESCRIPTION OF THE DRAWINGS

The present disclosure is described in conjunction with the appended figures, which are not necessarily drawn to scale:

FIG. 1 illustrates an example of a system in accordance with aspects of the present disclosure;

FIG. 2 illustrates details of a scheduling machine in accordance with at least some examples of the present disclosure;

FIG. 3 illustrates details the APIs used to interact with a scheduling machine in accordance with at least some examples of the present disclosure;

FIG. 4 illustrates details of an application integration in accordance with at least some examples of the present disclosure;

FIG. 5A is a flow diagram illustrating a first part of a first method in accordance with at least some examples of the present disclosure;

FIG. 5B is a flow diagram illustrating a second part of the first method in accordance with at least some examples of the present disclosure;

FIG. 6 is a block diagram illustrating details of a user journey in accordance with at least some examples of the present disclosure;

FIG. 7 is a flow diagram illustrating a third method in accordance with at least some examples of the present disclosure;

FIG. 8 is a flow diagram illustrating a fourth method in accordance with at least some examples of the present disclosure; and

FIG. 9 is a flow diagram illustrating a fifth method in accordance with at least some examples of the present disclosure.

### DETAILED DESCRIPTION

Before any examples of the disclosure are explained in detail, it is to be understood that the disclosure is not limited in its application to the details of construction and the arrangement of components set forth in the following description or illustrated in the following drawings. The disclosure is capable of other configurations and of being practiced or of being carried out in various ways. Also, it is to be understood that the phraseology and terminology used herein is for the purpose of description and should not be regarded as limiting.

While various examples will be described in connection with tracking the availability of resources and allocating timeslots for such resources in the form of clinical resources (e.g., clinicians, nurses, clinical equipment, surgical equipment, exam rooms, operating rooms, physical rooms, etc.), it should be appreciated that examples of the present disclosure are not so limited. In particular, examples of the present disclosure can be applied to the allocation of timeslots for any number of resource types including clinical and non-clinical resources.

Aspects of the present disclosure support the use of machine learning models that provide an avenue by which access to resources can be allocated in an intelligent and efficient manner. For example, aspects of the present disclosure support the ability to predict an availability of resources, track and/or predict a demand for such resources, and allocate such resources.

The terms “member,” “patient,” “individual,” “customer”, and “subject” may be used interchangeably herein.

Example aspects of the present disclosure are described with reference to the following figures.

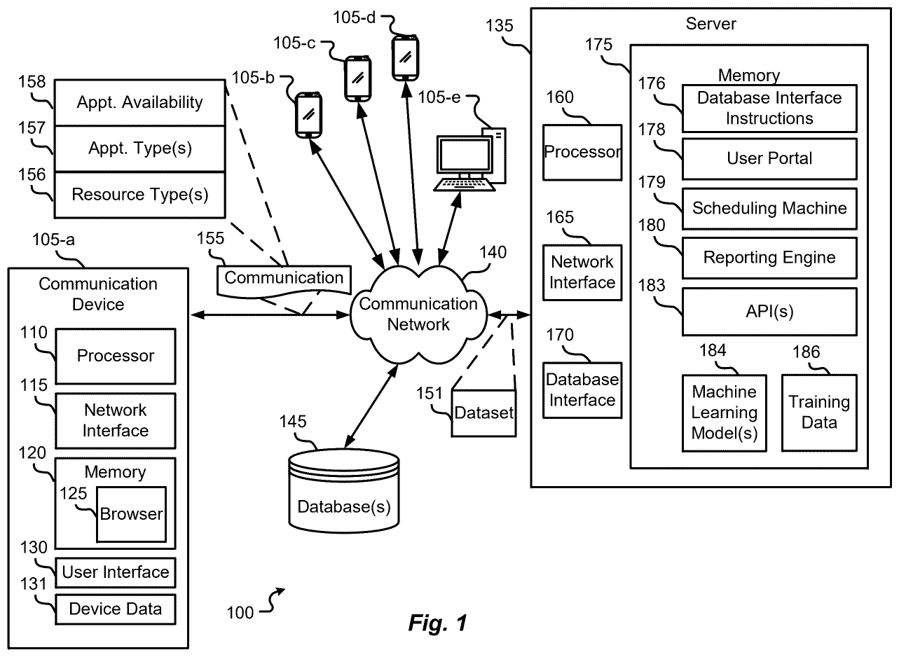

FIG. 1 illustrates an example of a system 100 in accordance with aspects of the present disclosure. The system 100, in some examples, may include one or more computing devices operating in cooperation with one another to allocate resources through the assignment of timeslots to resources and customers. The system 100 may be, for example, a healthcare management system.

The components of the system 100 may be utilized to facilitate one, some, or all of the methods described herein or portions thereof without departing from the scope of the present disclosure. Furthermore, the servers described herein may include example components or instruction sets, and aspects of the present disclosure are not limited thereto. In an example, a server may be provided with all of the instruction sets and data depicted and described in the server of FIG. 1. Alternatively, or additionally, different servers or multiple servers may be provided with different instruction sets than those depicted in FIG. 1.

The system 100 may include communication devices 105 (e.g., communication device 105-a through communication device 105-e), a server 135, a communication network 140, a provider database 145, and a member database 150. The communication network 140 may facilitate machine-to-machine communications between any of the communication device 105 (or multiple communication devices 105), the server 135, or one or more databases (e.g., a provider database 145, a member database 150). The communication network 140 may include any type of known communication medium or collection of communication media and may use any type of protocols to transport messages between endpoints. The communication network 140 may include wired communications technologies, wireless communications technologies, or any combination thereof.

The Internet is an example of the communication network 140 that constitutes an Internet Protocol (IP) network consisting of multiple computers, computing networks, and other communication devices located in multiple locations, and components in the communication network 140 (e.g., computers, computing networks, communication devices) may be connected through one or more telephone systems and other means. Other examples of the communication network 140 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 140 may include of any combination of networks or network types. In some aspects, the communication network 140 may include any combination of communication mediums such as coaxial cable, copper cable/wire, fiber-optic cable, or antennas for communicating data (e.g., transmitting/receiving data). In some examples, the communication network 140 may be considered untrusted with respect to an entity that is administering the server 135 or a cloud computing environment representing the server 135.

A communication device 105 (e.g., communication device 105-a) may include a processor 110, a network interface 115, a computer memory 120, a user interface 130, and device data 131. In some examples, components of the communication device 105 (e.g., processor 110, network interface 115, computer memory 120, user interface 130) may communicate over a system bus (e.g., control busses, address busses, data busses) included in the communication device 105. In some cases, the communication device 105 may be referred to as a computing resource. The communication device 105 may establish one or more connections with the communication network 140 via the network interface 115. In some cases, the communication device 105 may transmit or receive packets to one or more other devices (e.g., another communication device 105, the server 135, the provider database 145, the provider database 150) via the communication network 140.

Non-limiting examples of the communication device 105 may include, for example, personal computing devices or mobile computing devices (e.g., laptop computers, mobile phones, smart phones, smart devices, wearable devices, tablets, etc.). In some examples, the communication device 105 may be operable by or carried by a human user. In some aspects, the communication device 105 may perform one or more operations autonomously or in combination with an input by the user.

The communication device 105 may support one or more operations or procedures associated with requesting a resource and/or reserving a timeslot to access a resource at a point in the future. In some cases, the system 100 may include any number of communication devices 105, and each of the communication devices 105 may be associated with a respective entity.

The communication device 105 may render or output any combination of notifications, messages, reports, menus, etc. based on data communications transmitted or received by the communication device 105 over the communication network 140. For example, the communication device 105 may receive one or electronic communications 155 (e.g., from the server 135) via the communication network 140. Additionally, or alternatively, the system 100 may support communications of any electronic communications 155 between any device of the system 100, and the electronic communications 155 may include any combination of transmitted or received data as described herein.

In some aspects, the communication device 105 may render a presentation (e.g., visually, audibly, using haptic feedback, etc.) of the electronic communication 155 via the user interface 130. The user interface 130 may include, for example, a display, an audio output device (e.g., a speaker, a headphone connector), or any combination thereof. In some aspects, the communication device 105 may render a presentation using one or more applications (e.g., a browser application 125) stored on the memory 120. In an example, the browser application 125 may be configured to receive the electronic communication 155 in an electronic format (e.g., in an electronic communication via the communication network 140) and present content of the electronic communication 155 via the user interface 130. Illustratively and without limitation, the electronic communication 155 may provide a presentation that describes information associated with accessing a resource, which may include appointment availability 158, appointment type 157 information, and resource type information 156. As an example, the server 135 may provide a visual representation via the browser 125 of resource availability and particular timeslots in which a resource (or collection of resources) may be available to a customer. Also by the browser 125, the user of the communication device 105-a may be allowed to select and reserve timeslots or appointments with resources. As timeslots are reserved by one user of one communication device 105-a, users of other communication devices may be prohibited from reserving or accessing the same timeslot.

In some aspects, the server 135 may communicate the electronic communication 155 to a communication device 105 (e.g., communication device 105-a) of a member, a communication device 105 (e.g., communication device 105-b) of a clinic customer, a communication device 105 (e.g., communication device 105-b) of a healthcare provider or clinician, a communication device 105 (e.g., communication device 105-c) of an insurance provider, a communication device 105 (e.g., communication device 105-d) of a pharmacist or pharmacy, a communication device 105 (e.g., a communication device 105-e) of a clinic employee, or the like.

As noted above, the electronic communication 155 may include information describing appointment availability 158, appointment types 157, and resource types 156.

The appointment availability 158 may be presented in a graphical or calendar-based format such that timeslots of available appointment times are presented to a user of the communication device 105. The appointment type 157 may be presented along with the presentation of the appointment availability 158. As an example, the appointment type 157 may be provided as metadata or additional data describing a type of appointment that is associated with an available timeslot.

The resource type 156 may provide information describing the type or types of resource(s) that are available within a given timeslot for an appointment. Illustratively and without limitation, the combination of resource type 156 and appointment type 157 may describe at least one of the following: clinic name, appointment date, appointment time, slot identifiers, service identifiers, usernames, and appointment duration.

The database(s) 145 may include member electronic records (also referred to herein as a data records) stored therein. In some aspects, the electronic records may be accessible to a communication device 105 (e.g., operated by healthcare provider personnel, insurance provider personnel, a customer, a pharmacist, etc.) and/or the server 135. In some aspects, a communication device 105 and/or the server 135 may receive and/or access the electronic records from the database 145 based on a set of permissions. In an example, the communication device 105 and/or server 135 may access a dataset 151 (e.g., associated with a customer or members) from the database 145.

In some other aspects, the electronic records may include device data 131 obtained from a communication device 105 (e.g., communication device 105-a) associated with the member. For example, the device data 131 may include gyroscopic data, accelerometer data, beacon data, glucose readings, heart rate data, blood pressure data, blood oxygen data, temperature data, kinetics data, location data, motion data, a device identifier, and/or temporal data (e.g., a timestamp) measurable, trackable, and/or providable by the communication device 105 (or a device connected to the communication device 105) associated with the member.

In some aspects, the dataset 151 may include electronic medical record (EMR) data. The dataset 151 may include data describing clinic visits (historical or upcoming), insurance medical claims, pharmacy claims, and/or insurance claims made by the member and/or a medical provider. Accordingly, for example, the dataset 151 may come from providers or payers, and claims included in the claims-based electronic data may be of various types (e.g., medical, pharmacy, etc.).

In some other aspects, the electronic records may be inclusive of aspects of a member's health history and health outlook. The electronic records may include a number of fields for storing different types of information to describe the member's health history and health outlook. As an example, the electronic records may include personal health information (PHI) data. The PHI data may be stored encrypted and may include member identifier information such as, for example, name, address, member number, social security number, date of birth, etc. In some aspects, the electronic records may include treatment data such as, for example, member health history, member treatment history, lab test results (e.g., text-based, image-based, or both), pharmaceutical treatments and therapeutic treatments (e.g., indicated using predefined healthcare codes, treatment codes, or both), insurance claims history, healthcare provider information (e.g., doctors, therapists, etc. involved in providing healthcare services to the member), in-member information (e.g., whether treatment is associated with care), location information (e.g., associated with treatments or prescriptions provided to the member), family history (e.g., inclusive of medical data records associated with family members of the member, data links to the records, etc.), or any combination thereof. In some aspects, the electronic records may be stored or accessed according to one or more common field values (e.g., common parameters such as common healthcare provider, common location, common claims history, etc.). In some aspects, the system 100 may support member identifiers based on which a server 135 and/or a communication device 105 may access and/or identify key health data per member different from the PHI data.

The server 135 may include a processor 160, a network interface 165, a database interface 170, and a memory 175. In some examples, components of the server 135 (e.g., processor 160, a network interface 165, a database interface 170, and a memory 175) may communicate via a system bus (e.g., any combination of control busses, address busses, and data busses) included in the server 135. Aspects of the processor 160, network interface 165, database interface 170, and memory 175 may support example functions of the server 135 as described herein. For example, the server 135 may transmit packets to (or receive packets from) one or more other devices (e.g., one or more communication devices 105, another server 135, the provider database 145, the provider database 150) via the communication network 140. In some aspects, via the network interface 165, the server 135 may transmit database queries to one or more databases (e.g., provider database 145, member database 150) of the system 100, receive responses associated with the database queries, or access data associated with the database queries.

In some aspects, via the network interface 165, the server 135 may transmit one or more electronic communications 155 described herein to one or more communication devices 105 of the system 100. The network interface 165 may include, for example, any combination of network interface cards (NICs), network ports, associated drivers, or the like. Communications between components (e.g., processor 160, network interface 165, database interface 170, and memory 175) of the server 135 and other devices (e.g., one or more communication devices 105, the provider database 145, the provider database 150, another server 135) connected to the communication network 140 may, for example, flow through the network interface 165.

The processors described herein (e.g., processor 110 of the communication device 105, processor 160 of the server 135) may correspond to one or many computer processing devices. For example, the processors may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 120 of the communication device 105, memory 175 of the server 135). For example, upon executing the instruction sets stored in memory 175, the processor 110 may enable or perform one or more functions of the communication device 105. In another example, upon executing the instruction sets stored in memory 175, the processor 160 may enable or perform one or more functions of the server 135.

The processors described herein (e.g., processor 110 of the communication device 105, processor 160 of the server 135) may utilize data stored in a corresponding memory (e.g., memory 120 of the communication device 105, memory 175 of the server 135) as a neural network. The neural network may include a machine learning architecture. In some aspects, the neural network may be or include one or more classifiers. In some other aspects, the neural network may be or include any machine learning network such as, for example, a deep learning network, a convolutional neural network, or the like. Some elements stored in memory 120 may be described as or referred to as instructions or instruction sets, and some functions of the communication device 105 may be implemented using machine learning techniques. In another example, some elements stored in memory 175 may be described as or referred to as instructions or instruction sets, and some functions of the server 135 may be implemented using machine learning techniques.

In some aspects, the processors (e.g., processor 110, processor 160) may support machine learning model(s) 184 which may be trained and/or updated based on data (e.g., training data 186) provided or accessed by any of the communication device 105, the server 135, the provider database 145, and the member database. The machine learning model(s) 184 may be built and updated by any of the engines described herein based on the training data 186 (also referred to herein as training data and feedback). For example, the machine learning model(s) 184 may be trained with feature vectors of clinic visits for users, customer feedback, and the like.

In an example, the machine learning model(s) 184 may be trained with multiple training sets that include feature vectors of members. Initially, the machine learning model(s) 184 may be trained with a first training set and a second training set that are developed based, at least in part, on historical performance of a different system. In such a configuration, the first and second training set may correspond to default or base training sets that are generic in nature.

In another example, aspects of the present disclosure include training the machine learning model(s) 184 with a third training set that includes feature vectors of members (e.g., accessed from provider database 145 or member database 150) for which a diagnosed medical condition was correlated to measured biometric information of the members.

In some other examples, aspects of the present disclosure include creating a fourth training set based on data included in any of the first through third training sets.

In some aspects, training the machine learning model(s) 184 may be based on a target of optimizing resource utilization, minimizing customer wait time, maximizing successful timeslot allocations, or the like. For example, training may include building and validating the machine learning model(s) 184 generalized scheduling and timeslot allocation. In some examples, training the machine learning model(s) 184 and prediction using the machine learning model(s) 184 may be implemented using GPU enabled edge nodes (e.g., at a communication device 105, at the server 135, etc.).

The machine learning model(s) 184 may be provided in any number of formats or forms. Example aspects of the machine learning model(s) 184, such as generating (e.g., building, training) and applying the machine learning model(s) 184, are described with reference to the figure descriptions herein.

Non-limiting examples of the machine learning model(s) 184 include Decision Trees, gradient-boosted decision tree approaches (GBMs), Support Vector Machines (SVMs), Nearest Neighbor, and/or Bayesian classifiers, and neural-network-based approaches.

In some aspects, the machine learning model(s) 184 may include ensemble classification models (also referred to herein as ensemble methods) such as gradient boosting machines (GBMs). Gradient boosting techniques may include, for example, the generation of decision trees one at a time within a model, where each new tree may support the correction of errors generated by a previously trained decision tree (e.g., forward learning). Gradient boosting techniques may support, for example, the construction of ranking models for information retrieval systems. A GBM may include decision tree-based ensemble algorithms that support building and optimizing models in a stage-wise manner.

According to example aspects of the present disclosure described herein, the machine learning model(s) 184 may include Gradient Boosting Decision Trees (GBDTs). Gradient boosting is a supervised learning technique that harnesses additive training and tree boosting to correct errors made by previous models, or regression trees.

The machine learning model(s) 184 may include extreme gradient boosting (CatBoost) models. CatBoost is an ensemble learning method based on GBDTs. In some cases, CatBoost methods may have improved performance compared to comparable random forest-based methods. CatBoost methods are easily tunable and scalable, offer a higher computational speed in comparison to other methods, and are designed to be highly integrable with other approaches including Shapley Additive Explanations (SHAP) values.

In some aspects, the machine learning model(s) 184 may include ensemble classification models (also referred to herein as ensemble methods) such as random forests. Random forest techniques may include independent training of each decision tree within a model, using a random sample of data. Random forest techniques may support, for example, resource availability prediction herein using weighting techniques with respect to different data sources.

Various example aspects of the machine learning model(s) 184, inputs to the machine learning model(s) 184, and the training data 186 with respect to the present disclosure are described here.

The memory described herein (e.g., memory 120, memory 175) may include any type of computer memory device or collection of computer memory devices. For example, a memory (e.g., memory 120, memory 175) may include a Random Access Memory (RAM), a Read Only a Memory (ROM), a flash memory, an Electronically-Erasable Programmable ROM (EEPROM), Dynamic RAM (DRAM), or any combination thereof.

The memory described herein (e.g., memory 120, memory 175) may be configured to store instruction sets, neural networks, and other data structures (e.g., depicted herein) in addition to temporarily storing data for a respective processor (e.g., processor 110, processor 160) to execute various types of routines or functions. For example, the memory 175 may be configured to store program instructions (instruction sets) that are executable by the processor 160 and provide functionality of any of the engines described herein.

The memory described herein (e.g., memory 120, memory 175) may also be configured to store data or information that is usable or capable of being called by the instructions stored in memory. Examples of data that may be stored in memory 175 for use by components thereof include machine learning model(s) 184 and/or training data 186 described herein.

Any of the engines described herein may include a single or multiple engines.

With reference to the server 135, the memory 175 may be configured to store instruction sets, neural networks, and other data structures (e.g., depicted herein) in addition to temporarily storing data for the processor 160 to execute various types of routines or functions. The illustrative data or instruction sets that may be stored in memory 175 may include, for example, database interface instructions 176, a user portal 178, a scheduling machine 179, and a reporting engine 180. The memory 175 may also store one or more Application Programming Interfaces (APIs) 183 to support interactions between various components of the system 100. In some examples, the reporting engine 180 may include data obfuscation capabilities via which the reporting engine 180 may obfuscate, remove, redact, or otherwise hide personally identifiable information (PII) from an electronic communication 155 prior to transmitting the electronic communication 155 to another device (e.g., communication device 105).

In some examples, the database interface instructions 176, when executed by the processor 160, may enable the server 135 to send data to and receive data from the database 145. For example, the database interface instructions 176, when executed by the processor 160, may enable the server 135 to generate database queries, provide one or more interfaces for system administrators to define database queries, transmit database queries to one or more databases 145, receive responses to database queries, access data associated with the database queries, and format responses received from the databases for processing by other components of the server 135.

The server 135 may use the user portal 178 to support interactions with browsers 125 of communication devices 105. In some examples, the user portal 178 may also include authentication capabilities that restrict or control user access to the scheduling machine 179 and other features of the server 135 unless and until a user has successfully authenticated themselves with the server 135.

The scheduling machine 179 and reporting engine 180, when executed by the processor 160, may cooperate with one another and utilize one or more machine learning models 184 to intelligently and efficiently present communication device(s) 105 with information regarding appointment availability for certain resources and/or services offered by such resources. The scheduling machine 179 and reporting engine 180 may also utilize the user portal 178 to present information regarding appointment availability 158, appointment types 157, and resource types 156 to the communication device 155. In some examples, the scheduling machine 179 may be primarily responsible for predicting or determining resource availability and offering timeslots to customers for access to such resources.

The reporting engine 180, when executed by the processor 160, may enable the server 135 to output one or more electronic communications 155 based on data generated by the scheduling machine 179. The reporting engine 180 may be configured to generate electronic communications 155 in various electronic formats, printed formats, or combinations thereof. Some example formats of the electronic communications 155 may include HyperText Markup Language (HTML), electronic messages (e.g., email), documents for attachment to an electronic message, text messages (e.g., SMS, instant messaging, etc.), combinations thereof, or any other known electronic file format. Some other examples include sending, for example, via direct mail, a physical representation (e.g., a letter) of the electronic communication 155.

The reporting engine 180 may also be configured to hide, obfuscate, redact, or remove PII data from an electronic communication 155 prior to transmitting the electronic communication 155 to another device (e.g., a communication device 105, the server 135, etc.). The reporting engine 180 may also be configured to hide, obfuscate, redact, and/or remove PII data from an electronic data record prior to transmitting the electronic data record to another device (e.g., a communication device 105). In some aspects, a communication device 105 may also be configured to hide, obfuscate, redact, or remove PII data from direct mail (e.g., a letter) prior to generating a physical representation (e.g., a printout) of an electronic communication 155. In some examples, the data obfuscation may include aggregating electronic records to form aggregated member data that does not include any PII for a particular member or group of members. In some aspects, the aggregated member data generated by the data obfuscation may include summaries of data records for member groups, statistics for member groups, or the like.

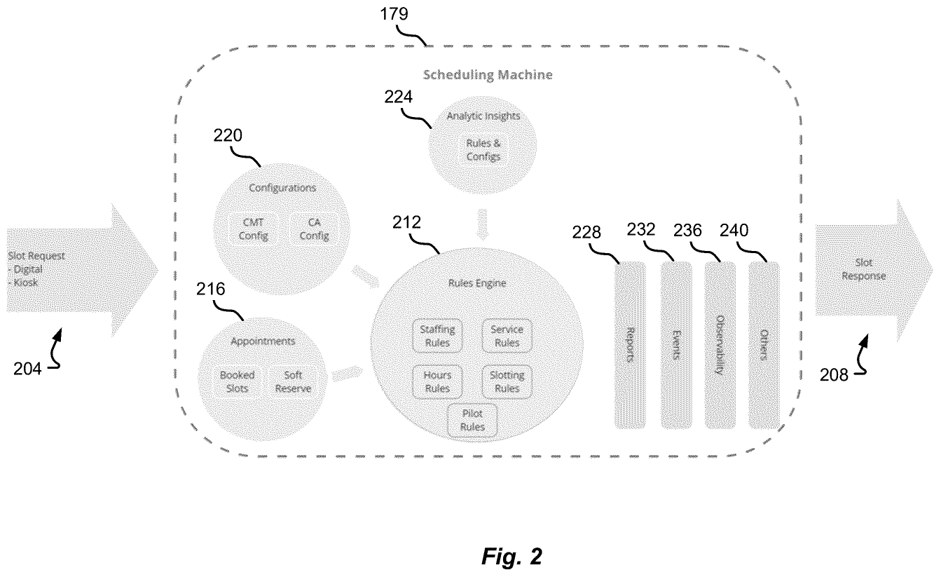

Example illustrative aspects of the system 100 are described with reference to FIGS. 2, 3, and 4.

FIG. 2 illustrates a block diagram 200 that supports aspects of the present disclosure. The block diagram 200 is described with reference to and may be implemented by aspects of the system 100 of FIG. 1. More specifically, FIG. 2 illustrates details of a scheduling machine 179 in accordance with at least some examples of the present disclosure. The scheduling machine 179 is specifically shown to include a rules engine 212 that operates based on appointment information 216, configuration information 220, and analytic insights 224.

The scheduling machine 179 may be configured to receive input(s) in the form of slot requests 204. The slot requests 204 may be received from a communication device 105 (e.g., via the user portal 178). As noted above, the communication device 105 providing the slot request may include any suitable type of device that interacts with the server 135 via a communication network 140. Non-limiting examples of communication devices 105 that can provide a slot request include a kiosk device (e.g., a purpose-built device provided in a clinic) and/or a mobile communication device, which may be owned/operated by a customer. Other suitable types of communication devices 105 may also be used to present the scheduling machine 179 with a slot request 204.

Upon receiving the slot request 204, the rules engine 212 may process the appointment information 216 along with configuration information 220 and analytic insights 224 to identify which, if any, timeslots are available for one or more resources. As noted above, timeslots may be presented in connection with a number of different types of resources. In the context of a clinical setting, the resources may include, but are not limited to human resources (e.g., physicians, nurses, care providers, etc.), physical resources (e.g., rooms, equipment, etc.), and combinations thereof.

The configuration information 220 may include clinic management tools (CMTs) as well as clinic admin (CA) configurations. The configurations may include a definition of rules or preferences that are specifically defined by a clinic or administrator thereof.

The analytic insights 224 may also include rules and configurations. The analytic insights 224 may include a definition of permissible hourly VPH, daily VPH, clinic VPH, and business-to-business requirements. In other words, the analytic insights 224 may provide rules in addition to configurations related to how much a resource should be utilized, either with respect to maximum thresholds or minimum thresholds, depending upon the resource and the desired utilization thereof.

The rules engine 212 of the scheduling machine 179 may process the slot request using the information 216, 220, 224, available thereto and apply one or more of staffing rules, service rules, hours rules, slotting rules, and pilot rules thereto. Based on the application of these rules, the rules engine 212 may resolve conflicts and eliminate timeslots that would otherwise be available if a booking of such a timeslot would result in a violation of one or more rules. Upon determining which timeslots, if any, are available, the rules engine 212 may generate a slot response 208 that is presented to the communication device 105 that transmitted the slot request 204. The slot response 208 may include information describing slot availability and further allow a user to book an available slot.

The scheduling machine 179 may also be configured to generate one or more reports 228 describing slot availability and/or slot assignment, account for events 232 that are not otherwise identified in appointments 216, identify which slots are observable 236, and account for other 240 considerations. In some examples, the scheduling machine 179 may use one or more data sets (e.g., appointment data sets 216, configuration data sets 220, and analytic insight data sets 224) and then apply the various rules in the rules engine 212 to identify slot availability. In some examples, batch jobs are created to run at periodic frequency to load analytic insights 224. As can be appreciated, the scheduling machine 179 may also create web services for slot availability, get appointments, confirm, cancel, reschedule, etc. to support the scheduling traffic.

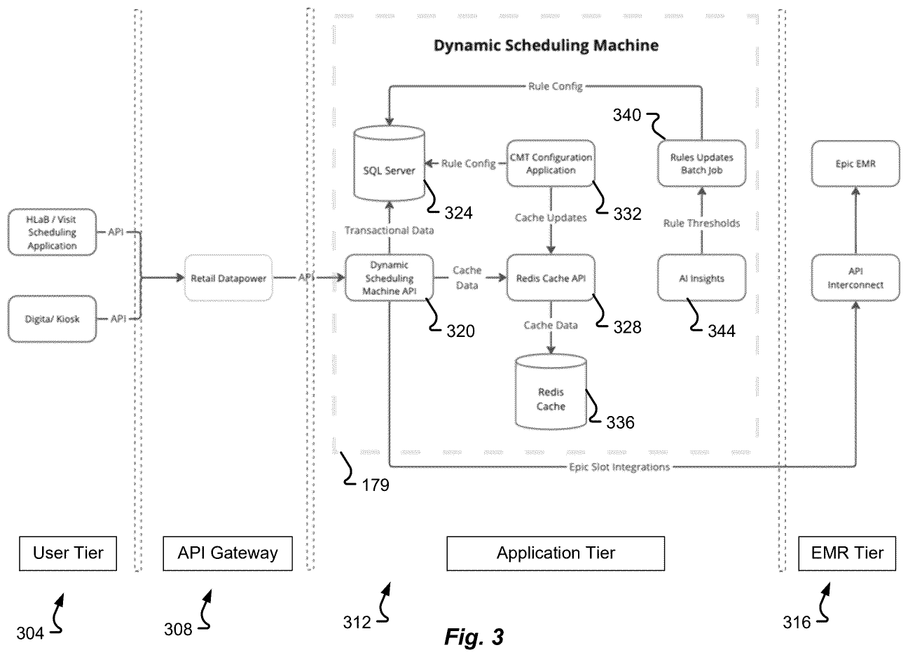

As can be seen in FIG. 3, the scheduling machine 179 may utilize one or more of a SQL server 324 and cache 336 to support operations of the rules engine 212. The scheduling machine 179 may be a part of an application tier 312 that interacts with a user tier 304 through an API gateway 308. The scheduling machine 179 may then utilize a system backend (e.g., EMR tier 316) to allocate timeslots based on general rules having clinic-specific rules overlaid thereon.

The scheduling machine 179 is further shown to include an API 320, the SQL server 324, a cache API 328, a configuration application 332, a cache 336, and a rules updates engine 340. The rules updates engine 340 may process rules updates within the scheduling machine 179 based on AI insights 344, which may be generated with outputs from the machine learning model(s) 184.

In some examples, configuration data sets 216, 220, 224 can be stored in the SQL server 324. Appointment creation, rescheduling and cancellation are first performed in the scheduling machine 179, and then are sent to the EMR tier 316 via an API interconnect, where they can be stored as part of an electronic medical record.

Rules updates 340 may be processed as batch jobs depending upon when an AI insight 344 is updated or created. For instance, the rules updates batch jobs 340 may only be initiated in response to certain events, after a certain period of time has passed since a previous rules update, or in response to the AI insights 344 detecting a change in conditions. For instance, the AI insights 344 may trigger a rules configuration update in response to detecting anomalous behavior regarding resource availability, timeslot allocation, timeslot requests, and/or seasonal changes. Upon detecting an anomaly, the AI insights 344 may instruct the rules updates batch job 340 to process a new set of rules configuration updates that account for the anomalous behavior detected by the AI insights 344.

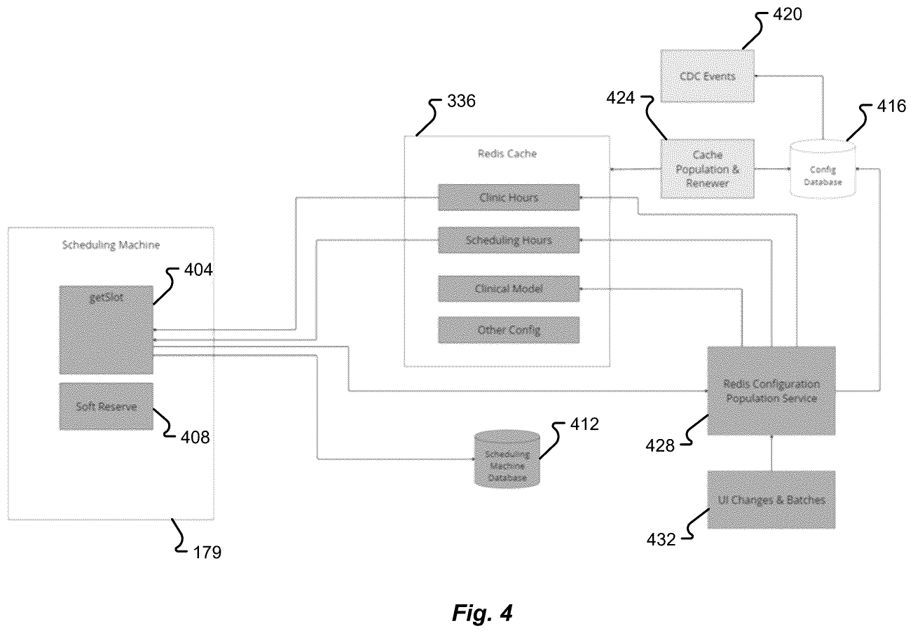

As can be seen in FIG. 4, the scheduling machine 179 may interact with a scheduling machine database 412 in addition to interacting with the cache 336. The scheduling machine 179 may implement a getslot function 404 as well as a soft reserve function 408 when responding to a slot request 204. The scheduling machine 179 may obtain clinic hours, scheduling hours, and other information from the cache 336. The cache 336 may be populated with a population service 428, which provides updates to the clinic hours, scheduling hours, and other configurations. The population service 428 may also provide clinical models to the cache 336 to help support the intelligent identification of available timeslots based on clinic hours and scheduling hours. The population service 428 may also populate the cache 336 based on UI changes 432 and other centrally-defined updates. The population service 428 may also be configured to update a configuration database 416, which provides Change Data Capture (CDC) events 420 as well as a cache population and renewer 424. Updates generated by the scheduling machine 179 may be shared with a scheduling machine database 412 as well as the population service 428. The scheduling machine database 412 may be configured to store information describing current slot availability and/or operations of the scheduling machine 179.

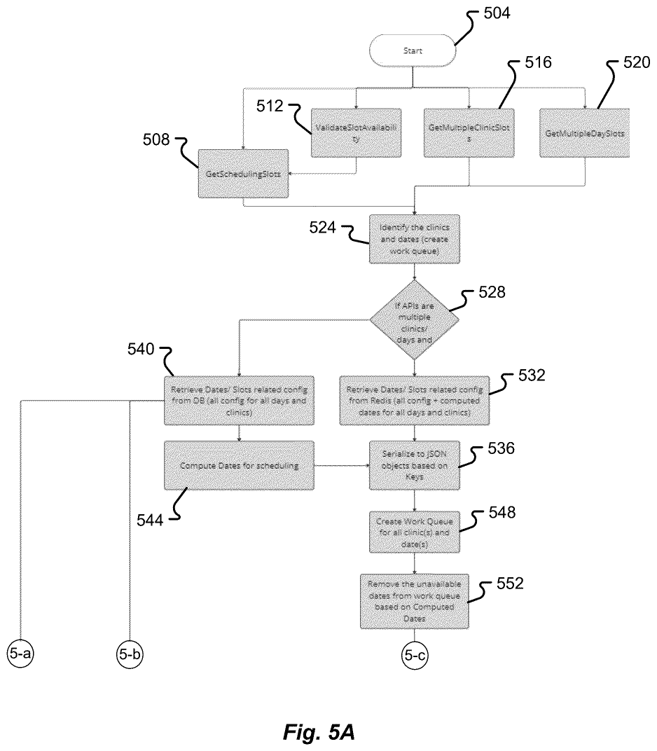

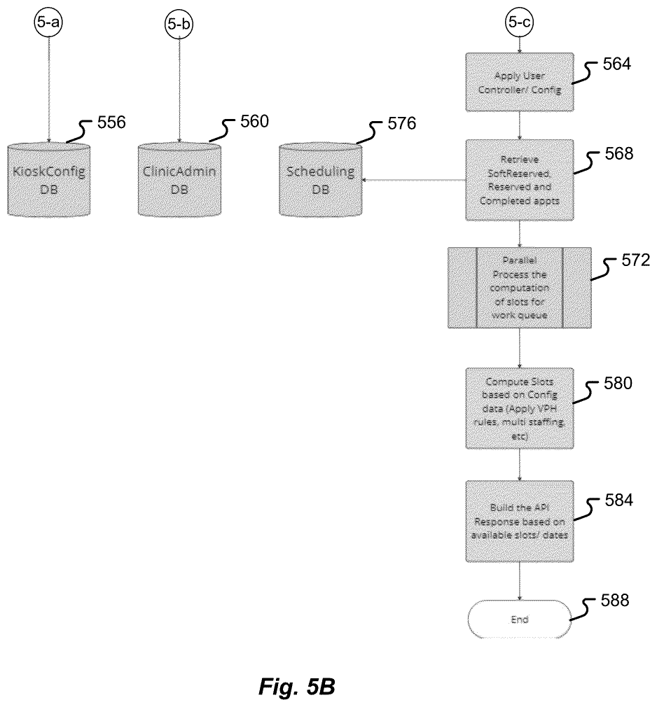

With reference now to FIGS. 5A through 9, various methods will be described in accordance with at least some examples of the present disclosure. FIGS. 5 through 9 illustrate various examples of process flows or methods. It should be appreciated that any single component or combination of components depicted and described herein can be configured to perform some or all of the steps in the illustrated process flows and methods, in any order. Moreover, steps from one process flow or method may be combined and/or exchanged with steps from other process flows or methods without departing from the scope of the present disclosure.

Referring initially to FIGS. 5A and 5B, a first method will be described in accordance with at least some examples. The first method may correspond to a method performed by the scheduling machine 179. The first method may begin at a start operation (step 504), then continue by performing a number of operations. The operations performed after the start operation include, without limitation, a get scheduling slots operation (step 508), a slot availability validation operation (step 512), a get multiple clinic slots operation (step 516), and a get multiple day slots operation (step 520). The get operations and validation operations associated therewith may be performed in parallel, partially or completely. As an example, the get operations 516 and 520 may be performed in parallel with the get scheduling slots operation, but the get scheduling slots operation may wait for the slot availability validation operation.

Following the get slots operations, the method may continue by identifying the clinics and dates that are represented in the timeslots returned from the get slots operations (step 524). In some examples, a work queue may be created to represent the clinics and dates having available timeslots.

The method may then proceed by determining if APIs are used for multiple clinics and/or whether timeslots are available for multiple days (step 528). Depending upon the determination of step 528, the method may include retrieving dates/slots for related configurations from a database (e.g., for all configurations for all days and for all clinics) (step 540) or the method may include retrieving dates/slots having related configurations from the cache 336 (step 532). If step 540 is performed, then the scheduling machine 179 may need to compute dates for scheduling (step 544). If step 532 is performed, then the scheduling machine 179 may retrieve dates and slots for any slot having all configurations plus the computed dates for all days and clinics.

The output from step 540 may be used to compute the dates for scheduling in step 544. In addition, the output from step 540 may be provided to a kiosk configuration database 556 as well as a clinic management database 560.

After step 532 or 544, the method may continue by serializing the slot objects to JSON objects based on keys (step 532). Thereafter, work queues may be created for all clinics and all date combinations (step 548). The unavailable dates may then be removed from the work queue based on the dates computed in step 532 or 544 (step 552).

The method may then continue by applying user/controller configurations (step 564). Based on the application of user/controller configurations, the scheduling machine 179 may retrieve soft reserve, reserved, and completed appointments (step 568). Information obtained from this step may be used to update a scheduling database 576 as well as perform a computation of available slots for a work queue (step 572). In some examples, the computation of slots for the work queue may be processed in parallel.

The method may further continue by computing available slots based on the configuration data sets 216, 220, 224 (step 580). After the available slots have been computed by the scheduling machine 179, the method may further continue with the scheduling machine 179 building the API response 208 with information describing the available slots (step 584). The slot response 208 generated in this step may include information describing the resource that is available in the slot, the location of the appointment, the type of appointment, the duration of the appointment, restrictions associated with the appointment, etc. The slot response may then be transmitted to the requestor (e.g., the communication device 105 that transmitted the slot request 204) via the communication network 140. The method may then end (step 588).

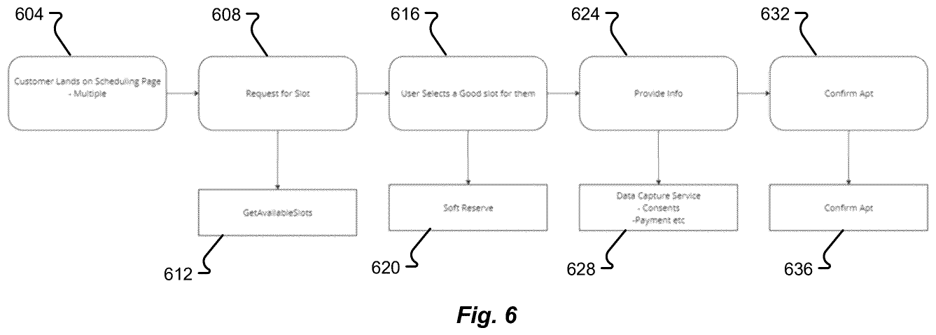

Referring now to FIG. 6, details of a user experience will be described in accordance with at least some examples of the present disclosure. In some examples, the user experience may include presenting a user with a GUI presentation of a scheduling page (e.g., via a browser 125) (step 604). The user may be allowed to land on one or multiple scheduling pages without departing from the scope of the present disclosure.

The user may then submit, via the scheduling page, a request for access to a resource. The request may be submitted in the form of a slot request 204 (step 608). In response to receiving the slot request 204, the scheduling machine 179 may perform one or multiple operations to identify available slots (step 612). The process of identifying available slots and which available slots should be presented to the user may be achieved using some or all of the steps described in connection with FIGS. 5A and 5B, for example.

Available slots may then be presented to the user via the browser 125. The user may be allowed to select a desirable slot (step 616). The initial user selection may result in a soft reservation of the slot (step 620). The user may then be provided with additional information regarding the initially-selected slot (step 624). The information provided to the user may include information describing the slot, the resources available in the slot, restrictions associated with the slot, and the like. For instance, the user may be presented with a description of the appointment type(s) and the resource type(s) that are made available within the selected slot.

The user may then be asked to provide one or more consents (e.g., healthcare consents) as well as payment information to complete the reservation of the slot (step 628). Upon capturing the appropriate final data from the user, the user may be presented with an appointment confirmation (step 632), which results in an appointment confirmation within the system 100. Specifically, the server 135 may reserve the slot, remove the slot from a list of available slots, and present the user with a communication that outlines the reserved slot (step 636).

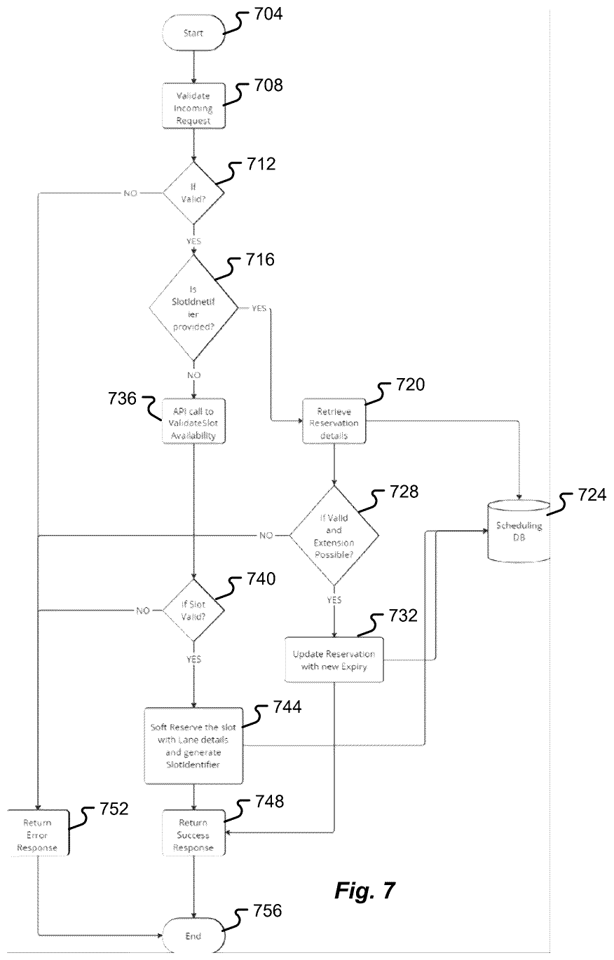

Referring now to FIG. 7, additional details of another method will be described in accordance with at least some examples of the present disclosure. The method may include aspects of performing a soft reservation of a timeslot or the soft extension/modification of an existing reservation for a timeslot. The method begins at a start operation (step 704) and continues by validating an incoming slot request 204 (step 708). A determination is made as to whether or not the slot request 204 corresponds to a valid slot request 204 or not (step 712). If the query of step 712 is answered negatively, then the method returns an error response (step 752). The error response may be provided to the requesting user via the browser 125.

If the query of step 712 is answered positively, then the method proceeds by determining if a slot identifier has been provided (step 716). If the query of step 716 is answered positively, then reservation details are retrieved for the identified slot (step 720) and the scheduling database is updated (step 724). The retrieval of reservation details may also be followed by determining if the slot is valid and if an extension of the appointment is possible (step 728). If the query of step 728 is answered negatively, then the method proceeds to step 752 and returns an error response. If the query of step 728 is answered positively, then the method proceeds by updating the reservation with a new expiration time (step 732) and then updating the scheduling database (step 724). The extension of the existing reservation may also include returning a success response to the requesting user (step 748). The success response may be provided by email or within the browser 125.

Referring back to step 716, if the query of step 716 is answered negatively, then the method proceeds by transmitting an API call to validate slot availability (step 736). Based on the response to the API call, the method may determine if the slot is valid (step 740). If the slot is invalid, then the method continues by returning an error response (step 752). If the slot is valid, then the method continues by providing a soft reservation for the requested slot (step 744). The soft reservation may also provide lane details and generate a slot identifier for the timeslot that was just allocated to the soft reservation.

Thereafter, the scheduling database may be updated (step 724) and a success response may be returned to the user that requested the timeslot (step 748). The method may then end at step 756.

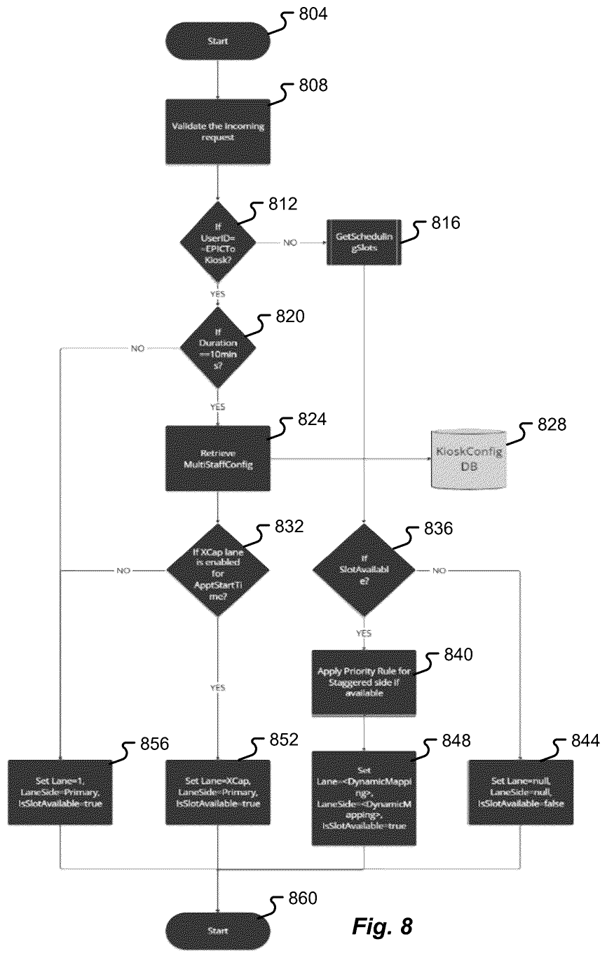

Referring now to FIG. 8, details of another method will be described in accordance with at least some examples of the present disclosure. The method may include a method of validating slot availability. The steps of this method may be performed in connection with other validation steps discussed herein (e.g., validation steps 708, 712, 740, etc.).

The method begins with a start operation (step 804), which may be triggered when a validation request is received (step 808). The validation request may be received at the scheduling machine 179 or within a validation engine of the scheduling machine 179. The method continues by determining if the request is received from a kiosk or from a communication device 105 owned by a customer (step 812). If the request is received from a kiosk as compared to a different type of communication device 105, then a different level of validation may be required. For example, if the validation request is received form a kiosk, then the method may continue by determining if the request is for a timeslot greater than or equal to a predetermined amount of time (step 820). In the illustrated example, the predetermined amount of time may correspond to a duration of ten minutes or more. If the duration is determined to be greater than or equal to the predetermined amount of time, then the method continues by setting aside the requested timeslot and setting the slot availability as TRUE (step 856). Thereafter, the method ends (step 860).

If duration is not greater than or equal to the predetermined amount of time, then the method continues by retrieving a multi-staff configuration (step 824). The multi-staff configuration may be retrieved for the current clinic in which the kiosk is situated and the current day. The kiosk configuration database may then be updated (step 828).

The method may further include determining if an excess capacity (XCap) lane configuration is turned on (step 832). In this step, the method may include determining if the appointment start time is within an acceptable window. If the XCap lane configuration is turned ON and appointment start time is within an XCap window, then the Lane is set as an XCap lane, the LaneSide is set as Primary and the slot availability is set as TRUE (step 852). Thereafter, the method ends (step 860).

Referring back to step 812, if the query is answered negatively, then the method proceeds with the scheduling machine 179 getting scheduling slots (step 816) and determining if the slots are currently available (step 836). If slots are available, then the scheduling machine 179 may apply priority rules for staggering slots side by side (step 840). Thereafter, the scheduling machine 179 may set each lane to a dynamic mapping setting and set lane sides to a dynamic mapping setting (step 848). The slot availability may also be set to TRUE. Thereafter, the method ends.

If the query of step 836 is answered negatively, then the lane and lane side are set to NULL and the slot availability is set to FALSE (step 844). Performance of step 844 may correspond to a determination that the slot has not been validated.

For slot requests coming from a machine other than an on-site kiosk, available slots may be retrieved by perform slot computations in which all rules and configurations are checked, even if a soft reservation is being provided.

Based on the computed slots, if a slot is available, priority rules may be applied rather than returning an error for Slot Not Available. A priority rule may be defined as to set a preference for lane and lane side. For lane side, if the slot is available on a staggered side, then the scheduling machine 179 is allowed to create the appointment on the staggered side. If not available on the staggered side, then the scheduling machine 179 may create the appointment on the primary side. In addition, the lane preference is smallest number from the lanes available with the slot.

In some examples, the scheduling machine 179 may be configured to map the final total duration to a slot duration based on a computed value of Recency Frequency Values (RFVs)/AgeBasedScheduling/Multiple Vaccines.

As noted above, the scheduling machine 179 may need to perform slot validation for conditions where the slot identifier has some value and conditions where the slot identifier doesn't have a value. If the slot identifier has some value, the scheduling machine 179 may retrieve the reservation details and validate if the reservation is valid based on reservation status and ExpiryTimeInUTC. If the reservation is valid, the scheduling machine 179 returns a success response with information. If the reservation is not valid, the scheduling machine 179 returns an error response stating “Reservation is expired and not available.” If the slot identifier doesn't have a value, then the scheduling machine 179 may validate the slot details using a get scheduling slots API computation.

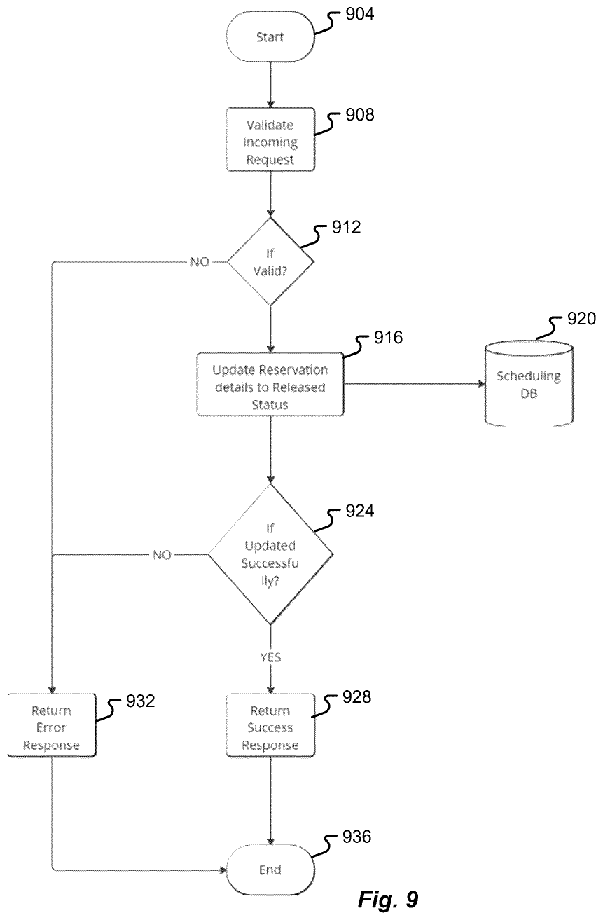

Referring now to FIG. 9, additional details of another method will be described in accordance with at least some examples of the present disclosure. The method may correspond to a method of releasing a slot reservation. The method begins with a start operation (step 904) and continues by validating the incoming request, which may correspond to a request to cancel or move a reservation of a slot (step 908). The method may continue by validating the request and determining if the request corresponds to a known slot that has been allocated to a customer (step 912). If the query is answered negatively, then the method continues by returning an error response (step 932).

If the query of step 912 is answered positively, then the method continues by updating the reservation details to indicate that the identified slot is being released and is no longer taken by the user (step 916). This may result in the scheduling database being updated (step 920). The method may also include determining if the update has been successfully completed (step 924). If the query is answered negatively, then an error response is returned (step 932). If the query is answered positively, then a success response is returned (step 928). Thereafter, the method ends (step 936).

While the examples illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed examples, configuration, and aspects.

A number of variations and modifications of the disclosure can be used. It would be possible to provide for some features of the disclosure without providing others.

In yet another example, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another examples, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another example, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the examples with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various examples, configurations, and aspects, includes components, methods, processes, systems and/or apparatus substantially as depicted and described herein, including various examples, subcombinations, and subsets thereof. Those of skill in the art will understand how to make and use the systems and methods disclosed herein after understanding the present disclosure. The present disclosure, in various examples, configurations, and aspects, includes providing devices and processes in the absence of items not depicted and/or described herein or in various examples, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

Moreover, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an example that is entirely hardware, an example that is entirely software (including firmware, resident software, micro-code, etc.) or an example combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A system, comprising:
a processor;
memory comprising data stored therein that is executable by the processor, wherein the data stored in the memory comprises:
user portal instructions that facilitate communications with one or more communication devices, wherein the user portal instructions are configured to receive a request for access to a resource in the form of a timeslot request;
a scheduling machine, comprising:
a plurality of configuration data sets; and
a rules engine that generates a response to the timeslot request by applying a plurality of rules to the timeslot request, wherein the plurality of rules utilize the plurality of configuration data sets as inputs thereto, and wherein the rules engine resolves one or more conflicts and eliminates timeslots that would otherwise be available if a booking of such a timeslot would result in a violation of a rule in the plurality of rules; and
a network interface that facilitates communication between the processor and the one or more communication devices via a communication network, wherein the network interface carries the timeslot request from the one or more communication devices to the processor and wherein the network interface provides the response to the timeslot request to the one or more communication devices.

2. The system of claim 1, wherein the user portal instructions comprise instructions that facilitate interactions with the one or more communication devices via a web browser.

3. The system of claim 1, wherein the plurality of configuration data sets comprises at least one of an analytic insights data set, an administrative configuration data set, and an appointment configuration data set.

4. The system of claim 1, wherein the memory further stores one or more machine learning models that are usable by the rules engine to identify one or more available timeslots.

5. The system of claim 4, wherein the one or more machine learning models receive an input from the rules engine identifying candidate timeslots and resources associated therewith and wherein the one or more machine learning models provide a prediction of availability with respect to the resources associated with the candidate timeslots.

6. The system of claim 1, wherein the scheduling machine further comprises a cache that stores information describing at least one of clinic hours, scheduling hours, clinical models, and configuration data.

7. The system of claim 6, wherein the scheduling machine further comprises a cache Application Programming Interface (API) that facilitates interactions between the cache and a scheduling machine server.

8. The system of claim 1, wherein the plurality of configuration data sets comprise at least one data set that dynamically changes in response to resource conditions.

9. The system of claim 8, wherein the at least one data set that dynamically changes in response to resource conditions is adjusted based on seasonal variations in resource availability.

10. The system of claim 9, further comprising one or more machine learning models that are trained with historical resource availability data and timeslot allocation data and, based on the training thereof, develop an understanding of the seasonal variations in resource availability.

11. The system of claim 1, wherein the scheduling machine is configured to support a soft reservation for a resource during at least one timeslot.

12. The system of claim 1, wherein the rules engine applies a first set of rules to the timeslot request when received from a kiosk, but applies a second set of rules to the timeslot request when received from a communication device other than a kiosk, and wherein the first set of rules is different from the second set of rules.

13. The system of claim 12, wherein the first set of rules presents a different set of available timeslots in response to the timeslot request as compared to the second set of rules.

14. The system of claim 1, wherein the scheduling machine is configured to run a plurality of rules updates in the form of a batch process.

15. The system of claim 14, wherein at least one rules update in the plurality of rules updates is triggered in response to the scheduling machine detecting an anomaly in resource availability.

16. The system of claim 1, wherein the response to the timeslot request comprises an indication of at least one of appointment availability, appointment type, and resource type.

17. The system of claim 1, wherein the communication network is untrusted with respect to an administrator of the scheduling machine.

18. The system of claim 1, wherein the plurality of configuration data sets provide a definition of permissible hourly Visits Per Hour (VPH), daily VPH, and clinic VPH.

19. The system of claim 1, wherein the scheduling machine is configured to perform two or more of a get scheduling slots, a get clinic slots, and a get day slots operation in parallel.

20. A non-transitory computer-readable medium comprising processor-executable instructions stored thereon that include:
user portal instructions that facilitate communications with one or more communication devices, wherein the user portal instructions are configured to receive a request for access to a resource in the form of a timeslot request; and
a scheduling machine, comprising:
a plurality of configuration data sets; and
a rules engine that generates a response to the timeslot request by applying a plurality of rules to the timeslot request, wherein the plurality of rules utilize the plurality of configuration data sets as inputs thereto, and wherein the rules engine resolves one or more conflicts and eliminates timeslots that would otherwise be available if a booking of such a timeslot would result in a violation of a rule in the plurality of rules.
